(19) United States
(12) Patent Application Publication
(10) Pub. No.: US 2012/0014751 A1
(43) Pub. Date: Jan. 19, 2012

(54) Method of providing an outlet on a subsea pipeline

(76) Inventors: Bemton Frederick Baugh, Houston, TX (US); Marc Moszkowski, Houston, TX (US)

(21) Appl. No.: 12/804,260

(22) Filed: Jul. 19, 2010

(51) Int. Cl. F16L 1/12

(52) U.S. Cl. 405/169

(57) ABSTRACT

The method of providing an accessible outlet on a subsea pipeline which has an unknown rotational orientation comprising connecting a first end of a flexible hose to the subsea pipeline, providing a multiplicity of connected bend restrictor sections around the flexible hose to restrict the bending of the hose, and providing buoyancy to the end of the hose such that the second end of the hose will remain accessible for future operations.

### TECHNICAL FIELD

This invention relates to the general subject of providing outlets for fluid connection to subsea pipelines.

### CROSS-REFERENCE TO RELATED APPLICATIONS

Not applicable.

### STATEMENT REGARDING FEDERALLY SPONSORED RESEARCH OR DEVELOPMENT

Not applicable

### REFERENCE TO A “MICROFICHE APPENDIX”

Not applicable

### BACKGROUND OF THE INVENTION

The field of this invention is that of pipelines in deep water where the process of laying the pipeline involves substantial stresses in the pipeline which can leave the exact orientation of the pipeline unknown. In the worst case scenario, the outlets on the pipeline can be oriented straight down and be completely inaccessible. Any orientation other than straight to the side or straight up typically involve substantial complications to any future tie-ins.

Outlets are needed for a variety of reasons. The first is simply the immediate connection of another pipeline. The potential for future tie-ins also exists as when a pipeline is laid, the full extent of future tie-ins is not known. In some cases the original supply of gas planned for the pipeline can be depleted and other reservoir locations can be found to tie in to the pipeline, if appropriate connection points are available.

In relatively deep water, water can accumulate in gas pipelines, slowing and sometimes completely stopping the flow. Frequently the production of natural gas also produces some water. When this water accumulates at the low point in the pipeline, it blocks the flow of water until the gas pushes the water in the upstream side down to the lowest point, with all the water pushed up the downstream side. The historic solution for this is to install a “pig” in the pipeline which seals on the internal bore of the pipeline and pumping it through the pipeline. As the pig sweeps through the pipeline, it will push the water out the other end. If the gas pressure is not sufficient, it will simply not be able to push the water up the other side.

Another problem which exists is the tendency for gas pipelines to form hydrates when water is present. At the pressures and temperatures of deepwater subsea pipelines, hydrates can form and block pipelines for months. Hydrates are something similar to crushed ice which are a mixture of water and natural gas.

There has long been a need for a more flexible way to make connections to subsea pipelines and a way to remove water from the pipelines, to remove other liquids from the pipeline, or to inject flow into the pipeline. Due to the probability that a contemporary pipeline will have an unpredictable orientation when it is laid on the sea floor, connection points are rarely added to pipelines or when they are they are provided with a large stabilizing skid to force them into a specific orientation.

### BRIEF SUMMARY OF THE INVENTION

The object of this invention is to provide a method of allowing pipelines to land in an unknown orientation when laid on the seafloor and still providing an outlet with a desired orientation.

A second object of this invention is to provide an outlet in a subsea pipeline capable of removing unwanted liquids from the pipeline.

A third object of this invention is to provide a method to allow the flow of gas or liquids from another subsea pipeline.

Another object of the present invention is to provide a method of flowing gases and/or liquids into a subsea pipeline from another pipeline.

### BRIEF DESCRIPTION OF THE DRAWINGS

FIG. 1 is a view of a pipeline being laid with the outlet of this invention.

FIG. 2. Is a view of the pipeline of FIG. 1 completely laid and being used to remove unwanted liquids from the pipeline.

FIG. 3 is a view of a pipeline outlet being connected for an auxiliary pipeline.

FIG. 4 is a perspective view of a portion of FIG. 1 showing the outlet exiting the pipeline as it is being laid from the vessel.

FIG. 5 is a partial section of the outlet showing the flexible hose and the surrounding bend restrictor.

FIG. 6 is a closer view of a bend restrictor section showing an anti-rotation key.

FIG. 7 is a perspective view of the outlet as would be seen if the subsea pipeline did not rotate during laying.

FIG. 8 is a side view of the view of FIG. 7.

FIG. 9 is an end view of FIG. 8 as seen along lines “9-9” of FIG. 8.

FIG. 10 is a view similar to FIG. 9, but with the subsea pipeline rotated 360 degrees.

FIG. 11 is a view similar to FIG. 10, but with the subsea pipeline rotated only 180 degrees.

FIG. 12 is a perspective view of FIG. 11.

### DETAILED DESCRIPTION OF THE INVENTION

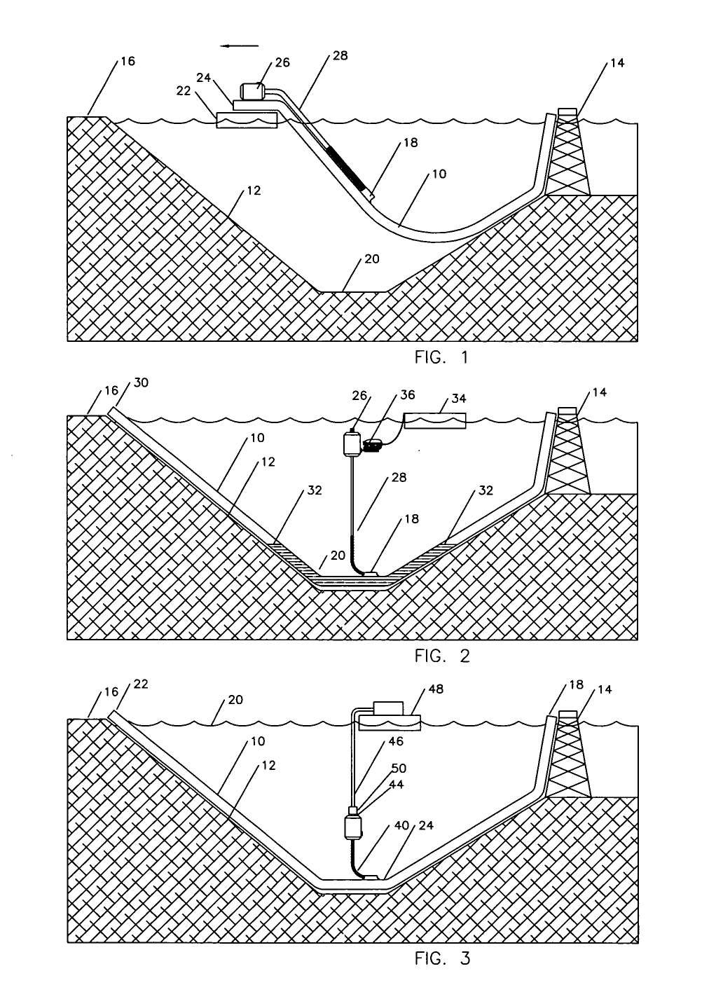

Referring now to FIG. 1, a subsea pipeline 10 is shown being laid on the seafloor 12 from an offshore structure 14 towards the shore 16. A pipeline outlet 18 is connected into subsea pipeline 10 in a position such that it will land in a low point or subsea valley 20 in the pipeline path along the seafloor 12.

The pipelay vessel 22 is shown with the pipeline end 24 and buoy 26 which is connected to hose 28 which in turn is connected to pipeline outlet 18. By attaching the hose 28 to the pipeline outlet 18 and in turn attaching the buoy 26 to the hose at the appropriate position, a single pipelay vessel 22 is able to both deploy the subsea pipeline 10 and the buoy 26.

Referring now to FIG. 2, the subsea pipeline 10 is fully laid on the ocean floor 12 with end 30 arriving at a shore facility (not shown). The pipeline outlet 18 is laid in the valley 20 with hose 28 going up to buoy 26 near the surface of the ocean. Water 32 is shown collected in the low portion of the subsea pipeline 10 in the valley 20. Sufficient accumulations of water in the valley of the pipeline will stop the flow of gas in the pipeline. The outlet 18, hose 28 and buoy 26 are utilized to remove the unwanted water from the subsea pipeline 10 by a surface vessel 34. In the embodiment shown a remotely operated vehicle (ROV) 36 is deployed from the surface vessel 34, engages the buoy 26 and operates a pump to pump the water out of the pipeline and to the surface. One method for doing this is to have a first hose with seawater flowing down to a motor proximate the pipeline outlet 18 to drive a pump to pump the pipeline water back up to the surface.

Referring now to FIG. 3, the hose 40 is shorter than hose 28 of FIG. 2 and buoy 42 provides a connection mandrel 44 facing upwardly. Pipeline 46 is lowered from vessel 48 with a connector 50 on the lower end for sealingly engaging with connection mandrel 44. At this time the pipeline 46 can be laid along the ocean floor to other facilities as required. A characteristic of subsea pipelines as they are laid from deepwater vessels is that they frequently twist slightly. When a steel pipeline such as 46 twists 180 degrees, the rigidity of the pipeline tends to prevent it from being twisted and will cause the flexible hose at the end to absorb all the twist. If the hose 40 is short, i.e. 50 feet long, and is twisted 180 degrees it will frequently give the hose spiral failure. As will be seen in FIG. 6, the hose can be reinforced against spiral failure without limiting its flexibility.

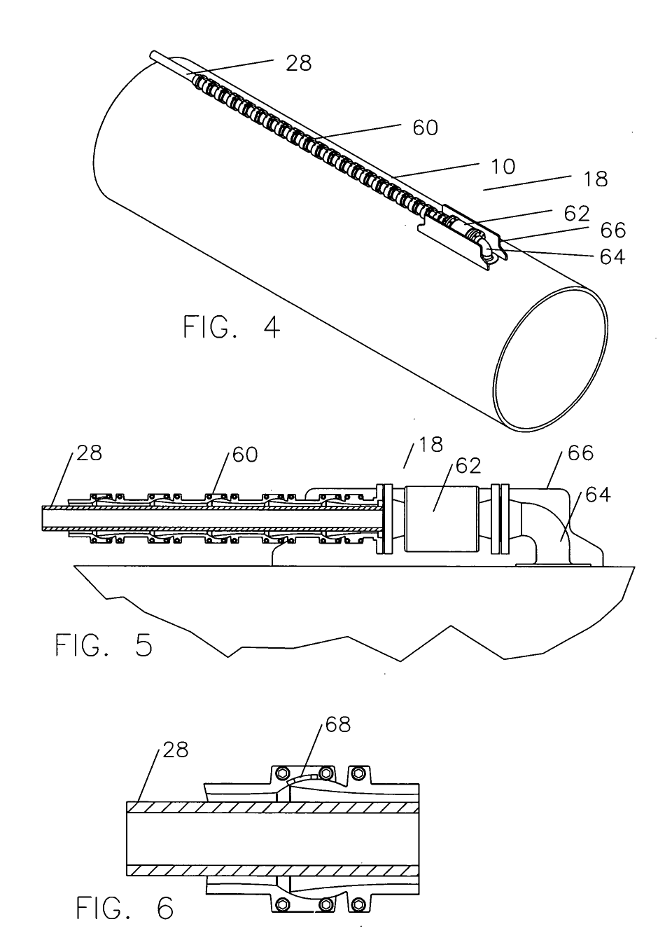

Referring now to FIG. 4, subsea pipeline 10 is shown with an outlet hose 28 protected at its lower end by a multiplicity of bend restrictor sections 60 and attached a control package 62. Control package section 62 can comprise shut-off valves, check valves, and/or pumps as are required for the particular purpose of the pipeline outlet. The control package section is in turn connected to elbow 64 into the subsea pipeline 10. On each side of the control package section, protective gussets 66 are shown. This is as it would be seen when being laid from the vessel before the buoy 26 is launched.

Referring now to FIG. 5, a closer partial view of the outlet 18 is seen showing the hose 28 inside the multiplicity of bend restrictor sections 60.

Referring now to FIG. 6, a single half section of bend restrictor is shown with an orientation key 68 which allows the bend restrictor sections to sustain torque and protect the hose 28 from being damaged by torsion.

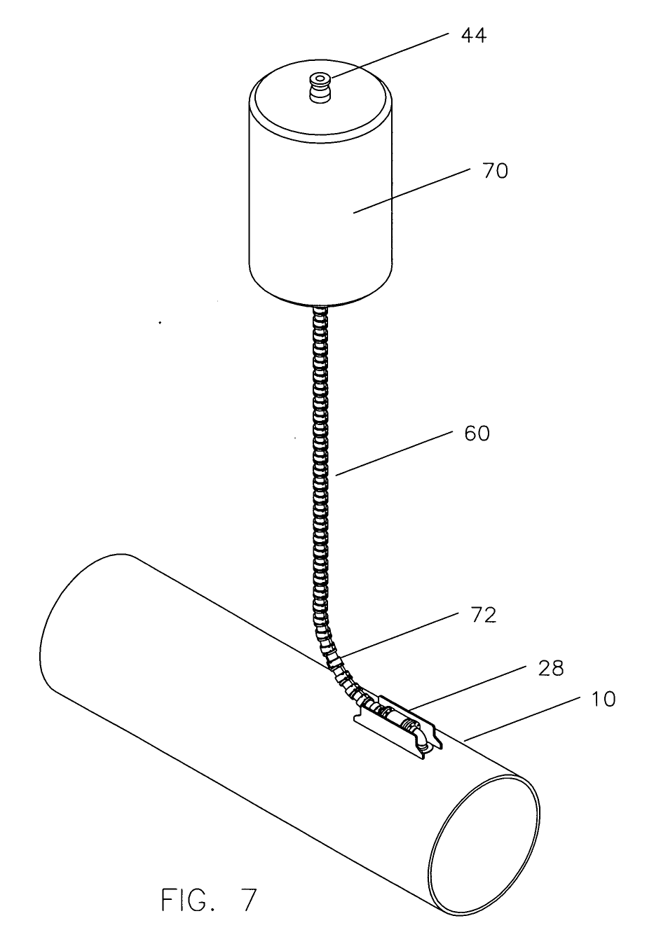

Referring now to FIG. 7, a perspective view of an outlet for attaching a pipeline is seen with the bend restrictor sections 60 going all the way up to the buoy 70 in order to protect the hose within from torque. As shown, the pipe did not rotate during the laying process, and the bend restrictors allow a simple 90 degree curve upwards toward the buoyancy.

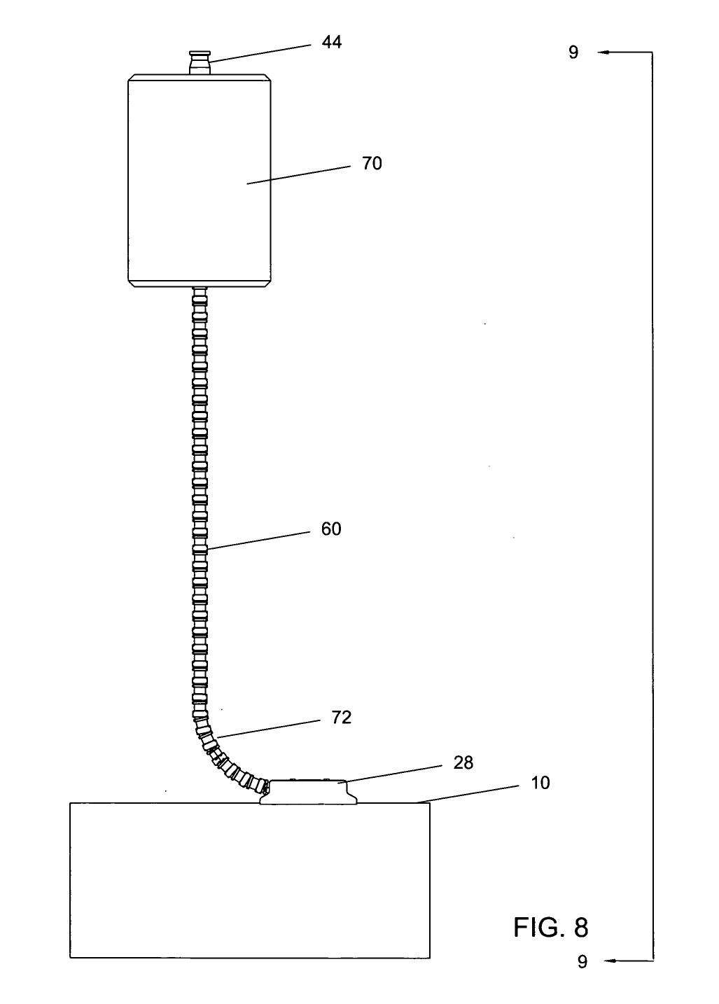

Referring now to FIG. 8, a side view of FIG. 7 is seen.

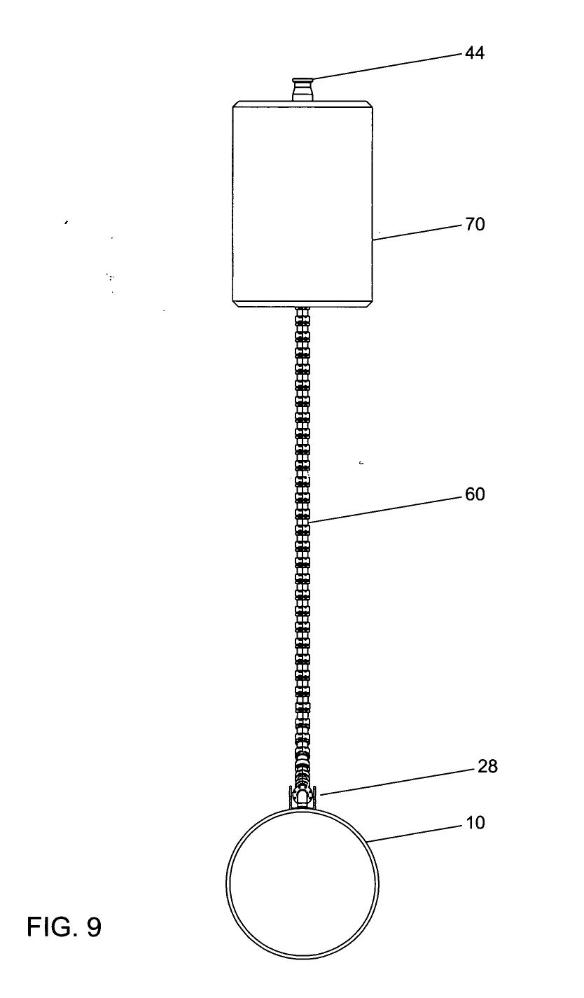

Referring now to FIG. 9, an end view of the arrangement of view 7 is seen.

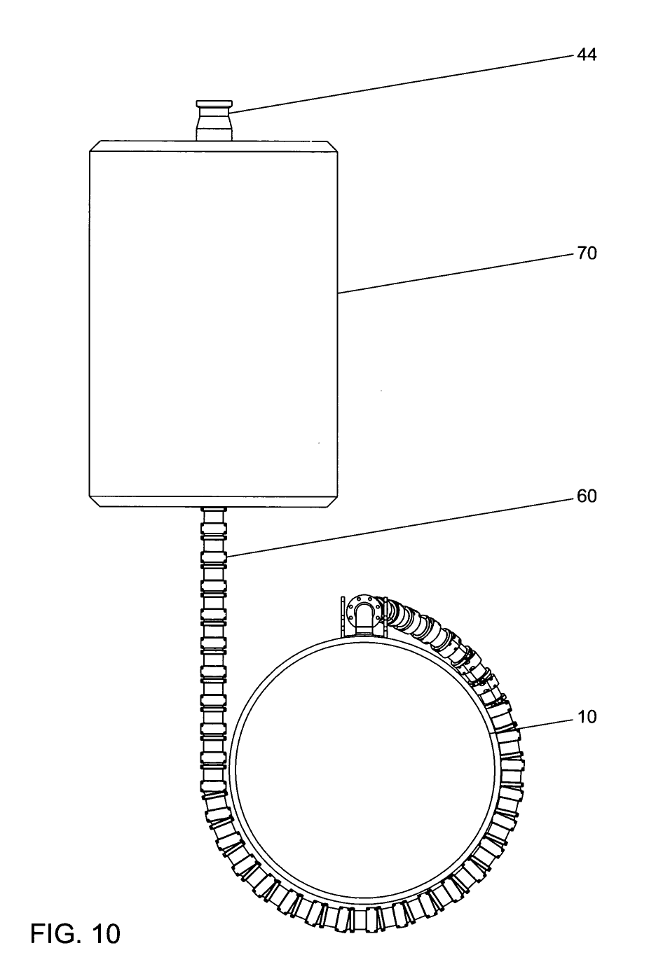

Referring now to FIG. 10, the view of FIG. 9 is shown with the subsea pipeline 10 rotated a full 360 degrees showing what happens when the pipe is rotated in the laying process. The pipe is rotated, but the connection 44 is still available for connection.

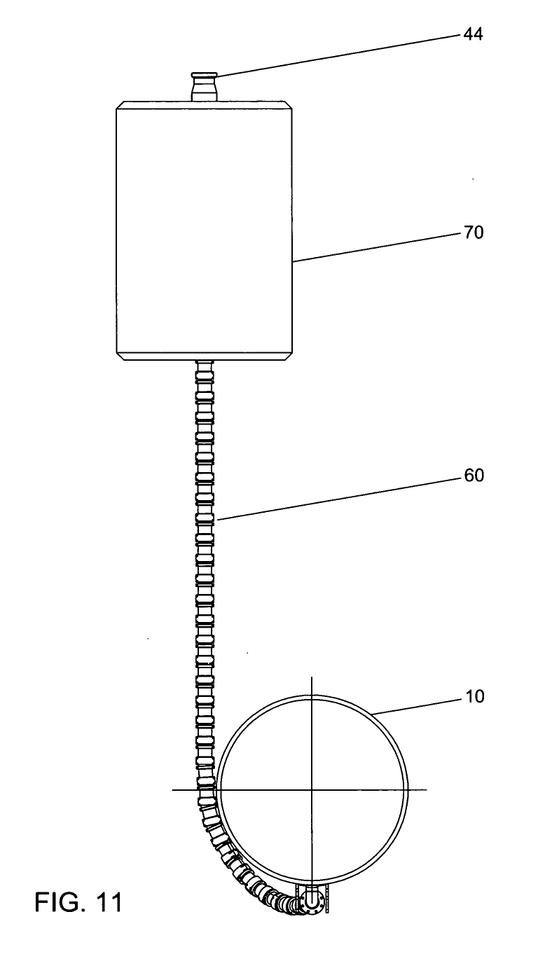

Referring now to FIG. 11, the view of FIG. 9 is shown with the subsea pipeline 10 rotated 180 degrees in the laying process.

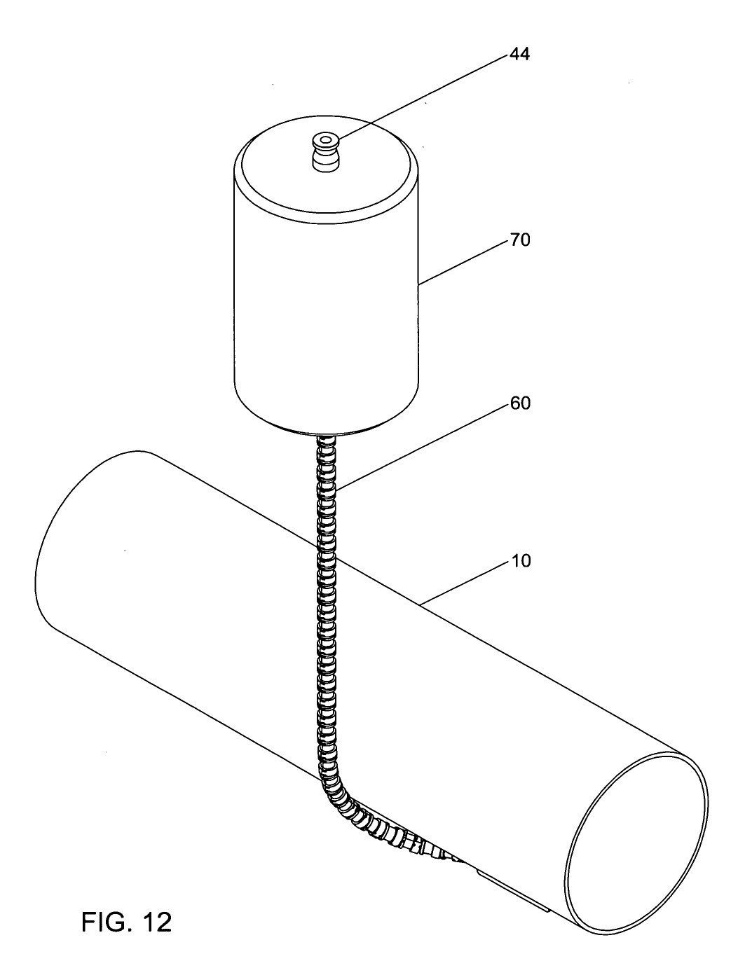

Referring now to FIG. 12, a perspective view of FIG. 11 is shown.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

That which is claimed is:

1. A method of providing an accessible outlet on a subsea pipeline on the seafloor at a location distal from the ends of said pipeline which has an unknown rotational orientation about the centerline of said pipeline comprising:
connecting a first end of a flexible hose to said subsea pipeline,
providing a multiplicity of connected bend restrictor sections around said flexible hose to restrict the bending of said hose, and
providing buoyancy to the second end of said hose such that said second end of said hose will remain accessible for future operations.

2. The method of claim 1, further comprising the centerline of said first end of said flexible hose is eccentric to and approximately parallel to the centerline of said subsea pipeline which has an unknown rotational orientation.

3. The method of claim 1, further comprising providing a pump to pump liquids from said subsea pipeline into said hose.

4. The method of claim 1, further comprising providing a check valve to prevent the flow of liquids from said flexible hose into said subsea pipeline.

5. The method of claim 1, further comprising providing a check valve to prevent the flow of liquids from said subsea pipeline into said flexible hose.

6. The method of claim 1, further comprising said multiplicity of bend restrictor sections are long enough to allow said subsea pipeline to rotate one full rotation and still allow said second end of said hose to remain vertical.

7. The method of claim 1, further comprising launching said flexible hose, multiplicity of bend restrictors, and said buoyancy from the same vessel said subsea pipeline is being laid from.

8. A method of providing an accessible outlet on a subsea pipeline eccentric to the centerline of said subsea pipeline on the seafloor at a location distal from the ends of said pipeline which has unknown rotational orientation about the centerline of said pipeline comprising:
connecting a first end of a flexible hose to said subsea pipeline,
providing a multiplicity of connected bend restrictor sections around said flexible hose to restrict the bending of said hose,
providing buoyancy to the second end of said hose such that said second end of said hose will remain accessible for future operations, and
providing said bend restrictor sections with torsional capacity and connecting said buoyancy to one of said bend restrictor sections to protect said hose from torsional stress.
